(19) United States
(12) Patent Application Publication
(10) Pub. No.: US 2008/0197723 A1
(43) Pub. Date: Aug. 21, 2008

(54) ELECTRIC MOTOR

(75) Inventors: Hayami ICHIHARA, Kariya-shi (JP); Shinichiro HAZAMA, Kariya-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi (JP)

(21) Appl. No.: 12/033,205

(22) Filed: Feb. 19, 2008

(30) Foreign Application Priority Data
Feb. 20, 2007 (JP) 2007-039786

(51) Int. Cl. H02K 11/02; H02K 11/00; H02K 13/00; H02K 5/24

(52) U.S. Cl. 310/51; 310/71; 310/245

(57) ABSTRACT

An electric motor includes a rotation shaft, a commutator fixed to the rotation shaft, an armature provided with armature coils electrically connected to the commutator, the armature rotatably housed in a motor housing, a brush slidably contacting with the commutator, a power feeding terminal including a positive electrode plate and a negative electrode plate, and supplying electric power supplied from a power source to the brush and an electric noise reduction device provided between the positive electrode plate and the negative electrode plate of the power feeding terminal.

### CROSS REFERENCE TO RELATED APPLICATIONS

This application is based on and claims priority under 35 U.S.C. §119 to Japanese Patent Application 2007-039786, filed on Feb. 20, 2007, the entire content of which is incorporated herein by reference.

### FIELD OF THE INVENTION

This invention generally relates to an electric motor provided with an electric noise reduction device.

### BACKGROUND

An electric motor disclosed in JP2004-56994A includes a conductive branch plate and connection stays in a power supply circuit which electrically connects power feeding terminals and leaf spring brushes. The conductive branch plate is electrically connected to power feeding terminals via a circuit breaker and is also electrically connected to the leaf spring brushes via inductors. The connection stays are electrically connected to the power feeding terminals and is also electrically connected to the leaf spring brushes via the inductors. The conductive branch plate is electrically connected to a grounding stay via condensers (i.e., electric noise reduction devices). The connection stays are electrically connected to the grounding stay via the condensers. Then, the grounding stay is electrically connected to a motor housing, at a motor housing side connection portion With the construction of the disclosed electric motor, conductive members are electrically connected to the motor housing via the ground member so that electric noise generated in the power supply circuit of the electric motor due to sliding contact between the brush and a commutator is absorbed by the motor housing for a noise reduction effect.

However, electric motors adapted, for example, to vehicles are downsized each year and thus clearances among parts in motor housings of the electric motors are also minimized to meet the necessity. Installing electric noise reduction devices in the motor housings results in larger motor housings. Also, there is a need to review whether or not interferences are caused between the electric noise reduction devices and other parts in the motor housing when installing the electric noise reduction devices in the motor housing, therefore an issue might arise that installation of the electric noise reduction devices to existing electric motors is difficult.

A need thus exists for an electric motor which is not susceptible to the drawback mentioned above.

### SUMMARY OF THE INVENTION

According to an aspect of the present invention, an electric motor includes a rotation shaft, a commutator fixed to the rotation shaft, an armature provided with armature coils electrically connected to the commutator, the armature rotatably housed in a motor housing, a brush slidably contacting with the commutator, a power feeding terminal including a positive electrode plate and a negative electrode plate, and supplying electric power supplied from a power source to the brush and an electric noise reduction device provided between the positive electrode plate and the negative electrode plate of the power feeding terminal.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross-sectional view illustrating an electric motor related to an embodiment of the present invention; and

FIG. 2 is a detailed cross-sectional view taken on line II-II of FIG. 1, illustrating a feed terminal related to the embodiment of the present invention.

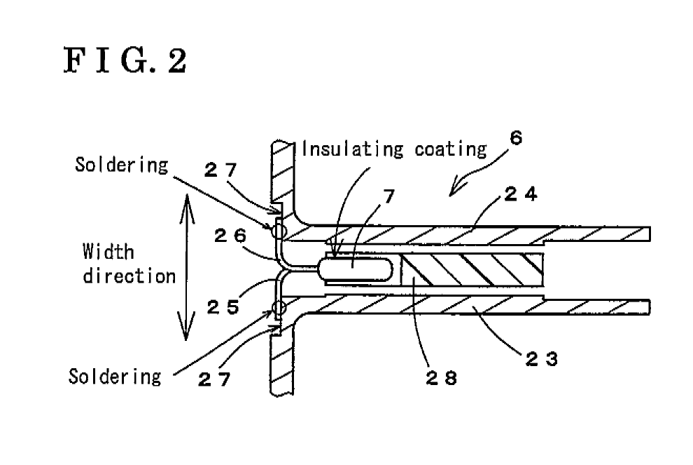

### DETAILED DESCRIPTION

An embodiment of the present invention related to a DC electric motor adapted, for example, to automotive apparatus is described in more detail below referring to the accompanying drawings.

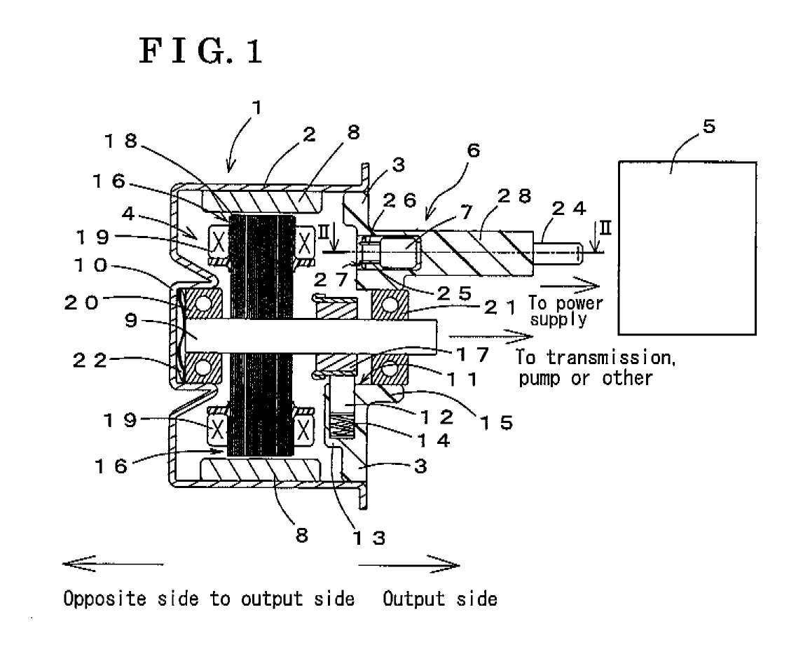

As shown in FIG. 1, an electric motor 1 includes a motor housing 2, an end plate 3, a rotor 4, a power feeding terminal 6 and a capacitor 7 (i.e., an electric noise reduction device). The motor housing 2 is shaped in a substantial cylinder with a closed-end and opens toward an output side. The end plate 3 is shaped in a plate and closes an opening of the motor housing 2. The rotor 4 is provided in a hollow portion formed by the motor housing 2 and the end plate 3. The power feeding terminal 6 is provided at the output side for supplying electric power supplied by a power source 5 to the rotor 4. The capacitor 7 is provided for reducing electric noise,

The motor housing 2 is made of metal and includes a plurality of magnets 8 equally spaced and fixed on an inner periphery of the motor housing 2 in a circumferential direction thereof The motor housing 2 also includes a bearing retaining portion 10 formed integrally therewith, at an opposite side to the output side of a rotation shaft 9.

The end plate 3 includes a through hole 11 opening through a center of the end plate 3 in a thickness direction thereof The end plate 3 is made of plastic and includes a brush holder 13 formed integrally therewith for holding a brush 12 slidably contacting with the rotor 4. The brush holder 13 is formed on the end plate 3, at the opposite side to the output side of the rotation shaft 9, and the brush 12 is pushed by a spring 14 so as to be pressed from the brush holder 13 to a direction of the rotation shaft 9.

Furthers a bearing retaining portion 15 is formed on the end plate 3, at the output side of the rotation shaft 9. The bearing retaining portion 15 is shaped in a ring being coaxial with the through hole 11 and protruding from a surface of the end plate 3 in the thickness direction thereof.

The rotor 4 includes an armature 16 shaped in a substantial cylinder, the rotation shaft 9 to which the armature 16 is coaxially fixed and a commutator 17 coaxiauly fixed to the rotation shaft 9.

The armature 16 includes a core 1S and armature coils 19 and 19, and is placed to radially face the magnets 8 fixedly arranged in the motor housing 2.

The rotation shaft 9 protrudes toward the output side of the end plate 3 through the through hole 11 formed on the end plate 3. A bearing 20 is fixed to the rotation shaft 9, at the opposite side of the output side of the rotation shaft 19 relative to the armature 16 and the commutator 17 in an axial direction. A bearing 21 is fixed to the rotation shaft 9, at the output side of the rotation shaft 19 relative to the armature 16 and the commutator 17 in the axial direction coaxially with the bearing 20. The bearing 20 is fixed to the bearing retaining portion 10 formed on the motor housing 2 by means of, for example, press-fitting. The bearing 21 is retained also by the bearing retaining portion 15 made of plastic and formed on the end plate 3, and is provided at the output side of the end plate 3. Consequently, the rotor 4 is rotatably supported by the motor housing 2 and the end plate 3, and the armature 16 rotates relative to the magnets 8. A spring washer 22 serving as a pushing member is provided between the bearing retaining member 10 and the bearing 20 in the axial direction so that the rotation shaft 9 is pushed toward the output side.

The commutator 17 is provided on the rotation shaft 9, at the output side relative to the armature 16 in the axial direction. The brush 12 is provided to face the commutator 17 in a radial direction of the commutator 17, thereby the brush 12 and the commutator 17 slidably contact each other.

The power feeding terminal 6, provided outside the motor housing 2, includes two electrode plates 23 and 24 (i.e., a positive electrode plate and a negative electrode plate), each being of a band plate shape, and arranged parallel to each other. The power feeding terminal 6 is provided at the output side of the rotation shaft 9 and connected to the power source 5. A transmission or a pump, for example, is provided at the output side of the rotation shaft 9, between the electric motor 1 and the power source 5, integrally with the rotation shaft 9.

The capacitor 7 is provided between the positive electrode plate 23 and the negative electrode plate 24 each having the band plate shape. The capacitor 7 is coated for insulation so as to remain electrically insulated from the electrode plates 23 and 24 of the power feeding terminal 6. A lead wire 25 (i.e., a first lead wire) of the capacitor 7 is soldered and electrically connected to one end face 27 of the positive electrode plate 23 of the power feeding terminal 6 and a lead wire 26 (i.e., a second lead wire) of the capacitor 7 is soldered and electrically connected to one end face 27 of the negative electrode plate 24 of the power feeding terminal 6. The capacitor 7 is enclosed by a cover 28 made of plastic and provided between the electrode plates 23 and 24 of the power feeding terminal 6. The cover 28 is plastic-molded integrally with the end plate 3.

The electric power from the power source 5 is supplied from the electrode plates 23 and 24 of the power feeding terminal 6 to the armature coils 19 and 19 via the brush 12 and the commutator 17. While the rotor 4 is rotated, direction of current flowing in the armature coils 19 and 19 changes. At this time, the electric noise is generated in a power supply circuit of the electric motor 1 due to the sliding contact between the brush 12 and the commutator 17, which is reduced by the capacitor 7.

Since the capacitor 7 is provided between the two electrode plates 23 and 24 of the power feeding terminal 6 provided outside the motor housing 2 in the embodiment related to the present invention, the motor housing 2 is downsized compared to motor housings of known electric motors. Further, there is no need to review whether or not interferences are caused between the capacitor 7 and other parts inside the motor housing 2. Furthermore, the capacitor 7 may be provided to an existing electric motor without affecting a design of the motor housing 2.

In addition, there is no need to increase a size of the power feeding terminal 6 in a width direction thereof because each the two electrode plates 23 and 24 of the power feeding terminal 6 is of the band plate shape and parallel to each other, thus allowing a compact-sized power feeding terminal 6.

The capacitor 7 is coated for insulation and arranged parallel to each of the electrode plates 23 and 24 of the power feeding terminal 6. Consequently, electrical insulation is maintained even when the capacitor 7 comes in contact with the electrode plates 23 and 24.

In addition, the capacitor 7 is connected to the power feeding terminal 6 without difficulty. This is because the lead wire 25 of the capacitor 7 is soldered and electrically connected to the one end face 27 of the electrode plate 23 and the lead wire 26 of the capacitor 7 is soldered and electrically connected to the one end face 27 of the electrode plate 24.

In addition, the cover 28 enclosing the capacitor 7 is provided between the two electrode plates 23 and 24 of the power feeding terminal 6. Consequently, when the transmission or the pump is provided at the output side of the rotating shaft 9, the cover 28 thus prevents the capacitor 7 from interfering with the transmission or the pump.

According to the embodiment of the present invention, the cover 28 is plastic-molded integrally with the end plate 3, however, a separate cover may be used. Also according to the embodiment, the capacitor 7 is used as the electric noise reduction device, however, other devices may be used.

Since the capacitor 7 is provided between the two electrode plates 23 and 24 of the power feeding terminal 6 in the embodiment related to the present invention, the motor housing 2 is downsized compared to those of the known electric motors where the capacitors are provided inside the motor housings. Further, there is no need to review whether or not the interferences are caused between the capacitor 7 and the other parts inside the motor housing 2. Furthermore, the capacitor 7 may be provided to the existing electric motor without affecting the design of the motor housing 2 when it becomes necessary to take measures against the electric noise.

According to the embodiment related to the present invention, each of the two electrode plates 23 and 24 of the power feeding terminal 6 is of the band plate shape, and is arranged parallel to and facing each other. Consequently, there is no need to increase the size of the power feeding terminal 6 in the width direction thereof.

According to the embodiment related to the present invention, the capacitor 7 is coated for insulation and arranged parallel to each of the electrode plates 23 and 24 of the power feeding terminal 6. Consequently, electrical insulation is maintained even when the capacitor 7 comes in contact with the electrode plates 23 and 24.

According to the embodiment related to the present invention, the capacitor 7 includes the lead wire 25 electrically connected to the one end face 27 of the electrode plate 23 of the power feeding terminal 6 and the lead wire 26 electrically connected to the one end face 27 of the electrode plate 24 of the power feeding terminal 6. Consequently, the capacitor 7 is mounted to the power feeding terminal 6 without difficulty even when the two electrode plates 23 and 24 of the power feeding terminal 6 are closely spaced.

According to the embodiment related to the present invention, the cover 28 is provided between the two electrode plates 23 and 24 of the power feeding terminal 6 for enclosing the capacitor 7. Consequently, when the transmission or the pump is provided at the output side of the rotating shaft 9, the cover 28 thus prevents the capacitor 7 from interfering with the transmission or the pump.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An electric motor, comprising:
a rotation shaft;
a commutator fixed to the rotation shaft;
an armature provided with armature coils electrically connected to the commutator, the armature rotatably housed in a motor housing;
a brush slidably contacting with the commutator;
a power feeding terminal including a positive electrode plate and a negative electrode plate, and supplying electric power supplied from a power source to the brush; and
an electric noise reduction device provided between the positive electrode plate and the negative electrode plate of the power feeding terminal.

2. The electric motor according to claim 1, wherein each of the positive electrode plate and the negative electrode plate of the power feeding terminal is of a band plate shape, and is arranged parallel to and facing each other.

3. The electric motor according to claim 1, wherein the electric noise reduction device is coated for insulation and arranged parallel to each of the positive electrode plate and the negative electrode plate of the power feeding terminal.

4. The electric motor according to claim 2, wherein the electric noise reduction device is coated for insulation and arranged parallel to each of the positive electrode plate and the negative electrode plate of the power feeding terminal.

5. The electric motor according to claim 1, wherein the electric noise reduction device includes a first lead wire electrically connected to one end face of the positive electrode plate of the power feeding terminal and a second lead wire electrically connected to one end face of the negative electrode plate of the power feeding terminal.

6. The electric motor according to claim 2, wherein the electric noise reduction device includes a first lead wire electrically connected to one end face of the positive electrode plate of the power feeding terminal and a second lead wire electrically connected to one end face of the negative electrode plate of the power feeding terminal.

7. The electric motor according to claim 3, wherein the electric noise reduction device includes a first lead wire electrically connected to one end face of the positive electrode plate of the power feeding terminal and a second lead wire electrically connected to one end face of the negative electrode plate of the power feeding terminal.

8. The electric motor according to claim 4, wherein the electric noise reduction device includes a first lead wire electrically connected to one end face of the positive electrode plate of the power feeding terminal and a second lead wire electrically connected to one end face of the negative electrode plate of the power feeding terminal.

9. The electric motor according to claim 1 further comprising:
a cover provided between the positive electrode plate and the negative electrode plate of the power feeding terminal for enclosing the electric noise reduction device.

10. The electric motor according to claim 2, further comprising:
a cover provided between the positive electrode plate and the negative electrode plate of the power feeding terminal for enclosing the electric noise reduction device.

11. The electric motor according to claim 3, further comprising:
a cover provided between the positive electrode plate and the negative electrode plate of the power feeding terminal for enclosing the electric noise reduction device.

12. The electric motor according to claim 4, further comprising:
a cover provided between the positive electrode plate and the negative electrode plate of the power feeding terminal for enclosing the electric noise reduction device.

13. The electric motor according to claim 5, further comprising:
a cover provided between the positive electrode plate and the negative electrode plate of the power feeding terminal for enclosing the electric noise reduction device.

14. The electric motor according to claim 6, farther comprising:
a cover provided between the positive electrode plate and the negative electrode plate of the power feeding terminal for enclosing the electric noise reduction device.

15. The electric motor according to claim 7, further comprising:
a cover provided between the positive electrode plate and the negative electrode plate of the power feeding terminal for enclosing the electric noise reduction device.

16. The electric motor according to claim 8, further comprising:
a cover provided between the positive electrode plate and the negative electrode plate of the power feeding terminal for enclosing the electric noise reduction device.
